(19) United States
(12) Patent Application Publication
(10) Pub. No.: US 2003/0218147 A1
(43) Pub. Date: Nov. 27, 2003

(54) Faucet for waterbowl

(76) Inventor: Fangzhen Zhen, Guangdong Province (CN)

Correspondence Address: RATNERPRESTIA, P O BOX 980, VALLEY FORGE, PA, 19482-0980, US

(21) Appl. No.: 10/409,218

(22) Filed: Apr. 8, 2003

(30) Foreign Application Priority Data
Apr. 30, 2002 (CN) 02227269.0

(51) Int. Cl. F16K 35/00

(52) U.S. Cl. 251/104

(57) ABSTRACT

A faucet for a waterbowl includes a control handle, a lifting seat, a valve cover, a valve body and a spindle assembly which controls the water flow on-off. The spindle assembly is provided within the valve body and the valve cover is mounted firmly the top of the valve body, with a spindle of the spindle assembly extending through the upper end of the valve cover and hinged to the lifting seat. The control handle is provided with a slidable locking mechanism to prevent the control handle from conducting pitching motion under normal state. The faucet may avoid mishandling and scalding.

### FIELD OF THE INVENTION

The present invention relates to a faucet for a waterbowl or a water faucet, and more particularly to such a faucet which is capable of preventing the water from flowing out of the waterbowl as a result of the user's mishandling.

### DESCRIPTION OF THE BACKGROUND ART

The conventional faucet for a waterbowl generally includes a spindle with a return spring and a control handle to which the spindle is hinged. The user operates the control handle to cause it pitching motion, thereby moving the spindle upwardly and downwardly to open and close the faucet. Although it is easy and convenient to operate and use such a faucet, the user may touch unconsciously the control handle to open the faucet, thereby causing the hot water to flow out of the waterbowl and scalding the user or the other persons around the user. Especially when a child is playing and presses the control handle without intention, the consequence would be more serious and inconceivable.

### SUMMARY OF THE INVENTION

An object of the invention is to overcome the problems of the conventional faucet for a waterbowl and provide an improved faucet which may prevent the control handle from conducting pitching motion under normal state. The faucet according to the present invention may avoid the user's mishandling, thereby preventing the user from being scalded by the hot water.

To achieve the above objects of the invention, there is provided a faucet for a waterbowl including a control handle, a lifting seat, a valve cover, a valve body and a spindle assembly which controls the water flow on-off. The spindle assembly is provided within the valve body and the valve cover is mounted firmly to the top of the valve body, with a spindle of the spindle assembly extending through the upper end of the valve cover and hinged to the lifting seat. The control handle is provided with a slidable locking mechanism to prevent the control handle from conducting pitching motion under normal state.

Since the faucet according to the present invention includes a slidable locking mechanism to prevent the control handle from conducting pitching motion under normal state, the faucet may not be opened until the control handle may conduct pitching motion by sliding the slipper, thereby avoiding any mishandling and scalding.

The foregoing and other objects, features and advantages of the present invention will become more apparent from the following detailed description of the present invention when taken in conjunction with the accompanying drawings.

### BRIEF DESCRIPTION OF THE DRAWINGS

FIG. 1 is a perspective view of the faucet for a waterbowl according to the present invention;

FIG. 2 is another perspective view of the faucet for a waterbowl of FIG. 1;

FIG. 3 is a perspective view of a waterbowl provided with the faucet according to the present invention;

FIG. 4 is an enlarged view of the circle K of FIG. 3;

FIG. 5 a perspective view of a bearing plate used in the faucet for a waterbowl according to the present invention; and

FIG. 6 is a perspective view of a slipper used in the faucet for a waterbowl according to the present invention.

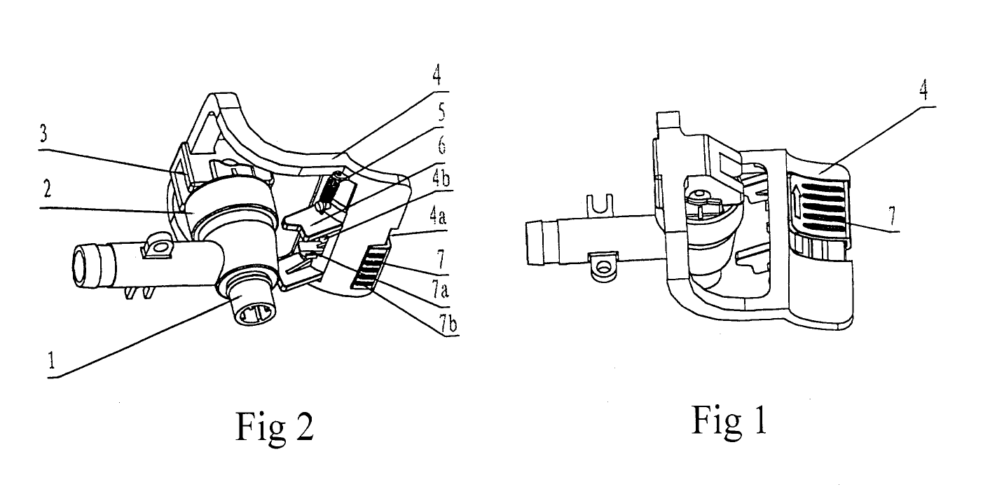

### DETAILED DESCRIPTION OF THE PREFERRED EMBODIMENTS

Reference will now be made in detail to the preferred embodiments of the present invention, examples of which are illustrated in the accompanying drawings. The same reference numeral in different drawings represents the same part.

The faucet for a waterbowl according to the present invention includes a control handle 4, a lifting seat 3, a valve cover 2, a valve body 1 and a spindle assembly which controls the water flow on-off. The spindle assembly is provided within the valve body 1 and the valve cover 2 is mounted firmly to the top of the valve body 1, with a spindle of the spindle assembly extending through the upper end of the valve cover 2 and hinged to the lifting seat 3. The control handle 4 is provided with a slidable locking mechanism to prevent the control handle 4 from conducting pitching motion under normal state.

The slidable locking mechanism includes a slipper 7, a bearing plate 6 and a return spring 5. The bearing plate 6 is provided with one or more stop pawls 6b. The slipper 7 at one end is attached engagably to a slideway 4a on the front end of the control handle 4 and at the other end inserted through a slideway 4b on the rear end of the control handle 4 and an opening 6a on the bearing plate 6 so that the slipper 7 is fixed to the bearing plate 6 below the control handle. The return spring 5 at one end is connected to the bearing plate 6 and at the other end to one side of the control handle 4. The stop pawls 6b on the bearing plate 6 contact a baffle plate 8 provided on the housing of waterbowl and may be aligned with the openings 8a formed on the baffle plate 8 by sliding movement of the slipper 7.

Preferably, the slipper 7 is fixed to the bearing plate 6 below the control handle 4 by means of the claws 7a formed on its other end.

The control handle 4 and the lifting seat 3 may be formed integrally or separately and then assembled together.

The slipper 7 may be provided with a plurality of projections 7b for antislipping.

The baffle plate 8 and the housing of waterbowl may be formed integrally or separately and then assembled together.

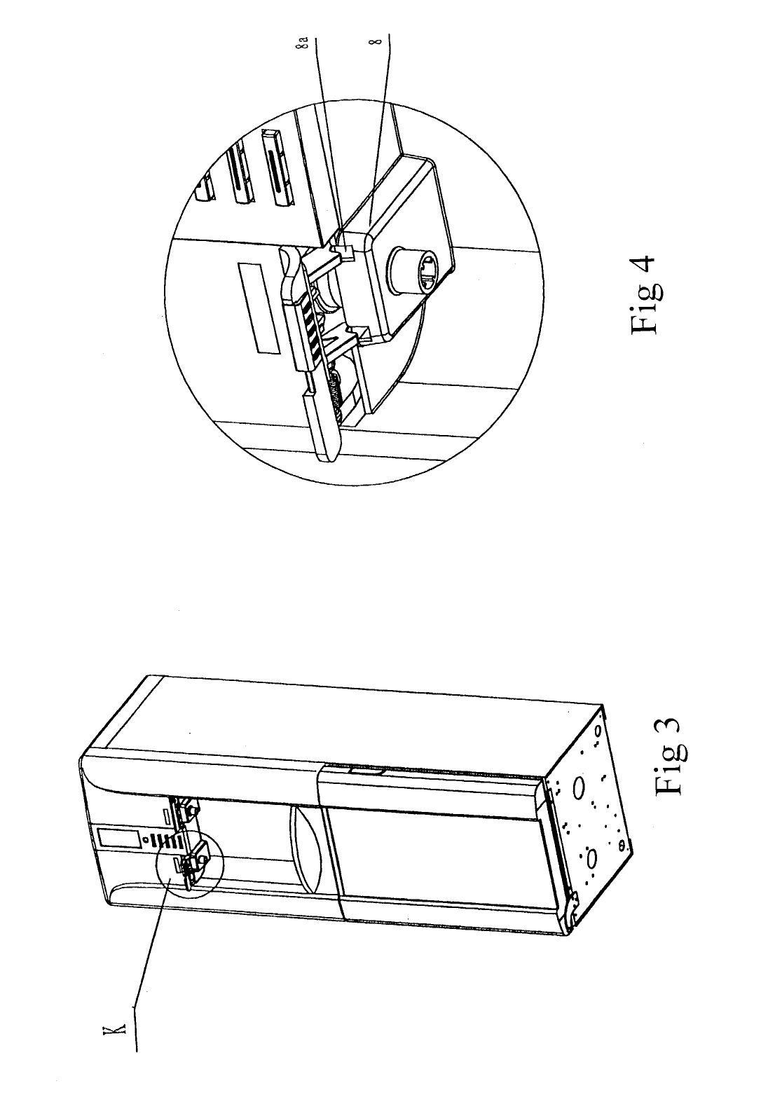

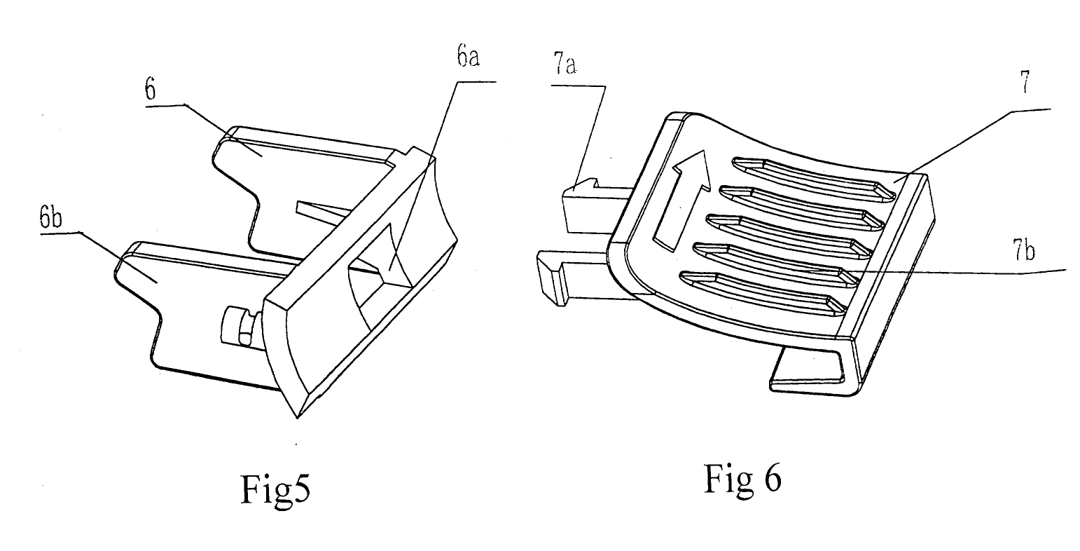

The faucet according to the present invention may be attached to a waterbowl, as shown in FIGS. 3 and 4. Under normal state, the stop pawls 6b formed on the bearing plate 6 contact the baffle plate 8 provided on the housing of waterbowl so that it is impossible to rotate the control handle 4 to conduct pitching motion. As a result, the control handle 4 is at a locked state. In order to flow water out of the waterbowl, the slipper 7 together with the bearing plate 6 is slid on the control handle 4 so that the stop pawls 6b formed on the bearing plate 6 are aligned with the openings 8a formed on the baffle plate 8. At this time,. the control handle 4 may be pressed downwardly and inwardly to move through the openings 8a formed on the baffle plate 8 so that the control handle 4 conducts pitching motion, thereby moving the spindle upwardly or downwardly to open or close the faucet.

As the present invention may be embodied in several forms without departing from the spirit or essential characteristics thereof, it should also be understood that the above-described embodiments are not limited by any of the details of the forgoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A faucet for a waterbowl including a control handle, a lifting seat, a valve cover, a valve body and a spindle assembly which controls the water flow on-off, the spindle assembly being provided within the valve body and the valve cover being mounted firmly to the top of the valve body, with a spindle of the spindle assembly extending through the upper end of the valve cover and hinged to the lifting seat, wherein the control handle is provided with a slidable locking mechanism to prevent the control handle from conducting pitching motion under normal state.

2. A faucet according to claim 1, wherein the slidable locking mechanism includes a slipper, a bearing plate provided with one or more stop pawls and a return spring; the slipper at one end being attached engagably to a slideway on the front end of the control handle and at the other end inserted through a slideway on the rear end of the control handle and an opening on the bearing plate so that the slipper is fixed to the bearing plate below the control handle; the return spring at one end being connected to the bearing plate and at the other end to one side of the control handle; and the stop pawls on the bearing plate contacting a baffle plate provided on the housing of waterbowl and being aligned with the openings formed on the baffle plate by sliding movement of the slipper.

3. A faucet according to claim 2, wherein the slipper is fixed to the bearing plate below the control handle by means of claws formed on its other end.

4. A faucet according to claim 1, wherein the control handle and the lifting seat are formed integrally.

5. A faucet according to claim 1, wherein the slipper is provided with a plurality of projections for antislipping.

6. A faucet according to claim 5, wherein the baffle plate and the housing of waterbowl are formed integrally.

7. A faucet according to claim 1, wherein the control handle and the lifting seat are formed separately and then assembled together.

8. A faucent according to claim 5, wherein the baffle plate and the housing of waterbowl are formed separately and then assembled together.
